(19) United States
(12) Patent Application Publication
(10) Pub. No.: US 2007/0274726 A1
(43) Pub. Date: Nov. 29, 2007

(54) Cross-connector for optical signals in time-division multiplex technology

(76) Inventors: Gottfried Lehmann, Petershausen (DE); Harald Rohde, Munchen (DE); Wolfgang Shairer, Unterschleissheim (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/590,241

(22) PCT Filed: Feb. 25, 2005
(86) PCT No.: PCT/EP05/50824

§ 371 Date: Aug. 22, 2006

(30) Foreign Application Priority Data
Feb. 25, 2004 (DE) 10 2004 009 139.0
Feb. 25, 2004 (DE) 10 2004 009 137.4

(51) Int. Cl. H04J 14/08

(52) U.S. Cl. 398/102; 398/98

(57) ABSTRACT

The invention relates to a cross-connector for optical time-division multiplexed signals, whose channels are switched by means of optical control pulses. One of the optical time-division multiplexed signals is fed to a respective optical switch that has an optical combiner connected downstream of the switch. A first number of channels that branch from a first optical time-division multiplexed signal is fed to a second optical combiner at a second optical switch. A switching operation of this type for the simultaneous supply of the two branched channel groups to the two optical combiners is actuated by means of high bit-rate control signals, which are fed to the optical switches. The optical control signals control the branching or addition of individual time-division multiplexed signals.

### CROSS REFERENCE TO RELATED APPLICATIONS

This application is the US National Stage of International Application No. PCT/EP2005/050824, filed Feb. 25, 2005 and claims the benefit thereof. The International Application claims the benefits of German application No. 102004009137.4 DE filed Feb. 25, 2004 and German application No. 102004009139.0 DE filed Feb. 25, 2004, all of the applications are incorporated by reference herein in their entirety.

### FIELD OF INVENTION

The invention relates to a cross-connector for optical signals according to the preamble of the first independent claim.

### BACKGROUND OF INVENTION

In a network with OTDM or optical time-division multiplex signals data of a time-division multiplex signal is multiplexed together with a high data rate G (e.g. G=160 GBit/s) from data channels with a low data rate—i.e. with a basic data rate F=G/M, where M is a whole number, e.g. M=16, F=10 GBit/s—using optical methods. Such a time-division multiplex signal with a high data rate G can be made up of a maximum total number of M=G/F channels.

Cross-connectors have to be implemented in every network to switch time-division multiplex signals or their channels. Generally the channels of the time-division multiplex signals are fed into a facility with a number of, for example, M=16 demultiplexers, where they are switched once again and forwarded into a new time-division multiplex signal by means of a further multiplex facility. This requires a great deal of time and effort and is very expensive. Also the signal to noise ratio deteriorates significantly as a result.

### SUMMARY OF INVENTION

The object of the invention is to specify a cross-connector for optical signals, which allows simple, purely optical switching of data in channels comprising time-division multiplex signals.

One means of achieving this object is a cross-connector with the features of an independent claim.

In the present invention reference is made to “switching, conducting, time delay, assignment, etc. of channels”, in order to facilitate reading. In such instances this means that transmitted data is switched for example from one channel to another or data is conducted via a channel, etc. There is no provision for a change in granularities here, e.g. by conversion from time-division multiplex to wavelength multiplex signals.

Based on a cross-connector for N optical signals, having N inputs and P outputs (N>1, P>1), with the N optical signals being provided as time-division multiplex signals having a number of channels, one optical time-division multiplex signal from for example two of the time-division multiplex signals is fed in each instance to an optical switch with an optical combiner connected downstream from it for the inventive switching of channels. At the first optical switch a first number of channels branching from the first optical signal are fed to the second optical combiner. A second number of channels branching from the second optical signal are also fed to the first optical combiner at the second optical switch. Such switching is controlled by means of optical control signals fed to the optical switches.

One significant advantage of the inventive cross-connector is that demultiplexing, in the sense of distribution of the original time-division multiplex signal to several series of low bit-rate signals to be switched, is not required, as switching takes place in an individual manner for each channel. This aspect results in a significant cost reduction and extremely fast switching speeds for any channel. Further corresponding complex multiplexing of the switched channels is also no longer necessary.

The inventive switching of the cross-connector is advantageously controlled by means of high bit-rate control signals with modulated pulse sequences. These control signals are generated on the basis of a number of conventional optical conductors connected in parallel, having optical modulators, e.g. with a basic data rate of F=10 GBit/s and different optical light paths and the outputs of which are optically coupled, such that a resulting pulse sequence with a bit rate of x times 10 GBit/s is generated after the optical conductors have been coupled. Such a device for generating control signals of any high bit-rate can be produced economically as an integrated optical component or be based on fibers of corresponding length. A device can thereby be provided, with which the pulse sequences can be varied or parts of the sequence can be partially disabled. In the case of the invention the control signals have the bit rate of the time-division multiplex signals, e.g. 160 GBit/s, as a maximum, so that channel-specific logic operations can be triggered without interrupting the data streams of the N time-division multiplex signals going into the cross-connector.

Generally the cross-connector with N inputs and P outputs has N(P−1) optical switches and P(N−1) optical combiners. As data channels with very high bit rates have to be switched, optical switches and combiners based on optical mechanisms are used. Electrical and mechanical devices are for the present not provided for this purpose, as they are much too slow. Technologies that can be used include for example gain transparent-ultraspeed nonlinear interferometers GT-UNI or switches based on four wave mixing FWM, cross phase modulation XPM or cross gain modulation XGM. Clock pulse and phase synchronization means are also required for the cross-connector but for the purposes of clarity these are not described in relation to the present invention. With the continuing rapid development of electrotechnical high-frequency technology it is conceivable that it will also be possible to use electronically based switches for such cross-connectors in a few years time.

Advantageous developments of the invention are set out in the subclaims.

The use of a single control signal to control a number of optical switches is particularly advantageous, if the same number and sequence of time-division multiplexed channels are to be switched.

Exemplary embodiments of the invention are described in more detail below with reference to drawings, in which:

### BRIEF DESCRIPTION OF THE DRAWINGS

FIG. 1 shows a first cross-connector for two incoming time-division multiplex signals with a different number of time-division multiplexed signals,

FIG. 2 shows a second cross-connector for two incoming time-division multiplex signals for direct crossover switching of the same time-division multiplexed channels,

FIG. 3 shows a schematic diagram of the first cross-connector with a device for the time synchronization of the time-division multiplex signals,

FIG. 4 shows a schematic diagram of a cross-connector with 4 inputs and 5 outputs,

FIG. 5 shows a schematic diagram of a device for generating any pulse sequences for control signals.

### DETAILED DESCRIPTION OF INVENTION

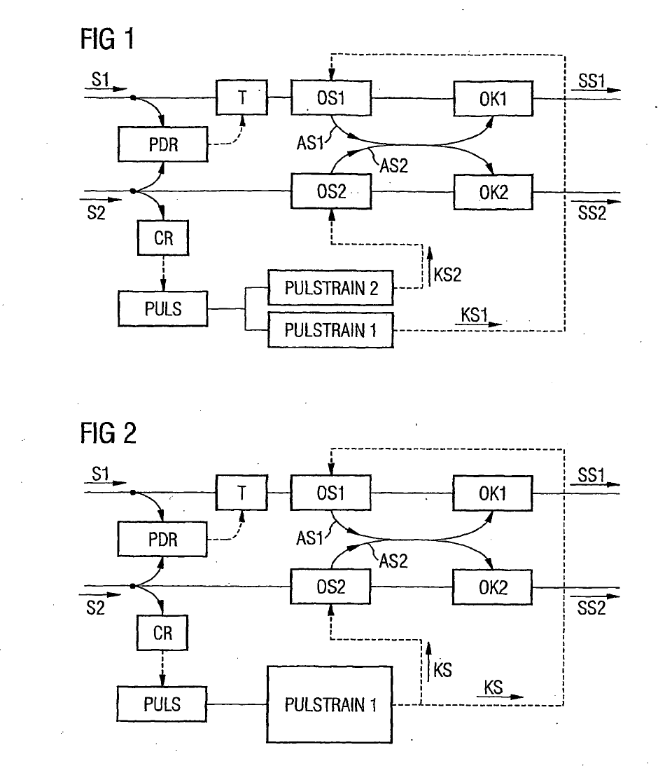

To clarify the subject matter of the invention, FIG. 1 specifies an exemplary embodiment, showing a cross-connector and its essential features for two incoming time-division multiplex signals S1, S2 and two outgoing time-division multiplex signals SS1, SS2. The optical time-division multiplex signals S1, S2 thereby have different numbers H, K of time-division multiplexed channels. The time-division multiplex signal S1, S2 is fed in each instance to an input of an optical switch OS1, OS2 with an optical combiner OK1, OK2 connected downstream. Any channels are switched—i.e. branched or conducted—at the optical switch OS1, OS2. At the first optical switch OS1 a first number J of channels AS1 branching from the first optical signal S1 are fed to the second optical combiner OK2. Also at the second optical switch OS2 a second number L of channels AS2 branching from the second optical signal S1 are fed to the first optical combiner OK1. Two control signals (KS1, KS2) are fed to the optical switches OS1, OS2, the pulse sequence of the control signals (KS1, KS2) being configured such that within the number H, K of time-division multiplexed channels any required channels to be branched—e.g. AS1 or AS2—of one of the two time-division multiplex signals—e.g. S1 or S2—is chosen in a selective manner and fed to an optical combiner—i.e. in this instance OK2 or OK1—that is not connected downstream from its optical switch—in this instance OS1 or OS2.

As set out above, the optical switches OS1, OS2 used here are purely optically triggered switches that allow rapid switching. In one variant a GT-UNI is used for switching. An input data signal is branched here by means of an optical control pulse in a semiconductor optical amplifier SOA, after the input data signal has first been split into two pulses that are polarized orthogonally in relation to each other.

The optical combiners OK1, OK2 used here have a detection unit to determine the occupancy of incoming time-division multiplexed channels and means for reciprocal time displacement or reassignment and addition of channels, so that their incoming channels are combined in a collision-free manner to generate the outgoing time-division multiplex signals SS1, SS2.

A time delay element T is connected upstream from the first optical switch, so that an optional relative time or phase delay between the two incoming time-division multiplex signals S1, S2 is checked and set correctly in the event of any undesirable displacement, for example by means of a phase detector and regulator PDR. A control unit CR determines the time delay setting of the time-division multiplex signals S1, S2 and also synchronizes the phase of the high bit-rate control signals KS1, KS2 with this.

Depending on which channels AS1, AS2 are branched in the time-division multiplex signals S1, S2, the pulse sequences of both control signals KS1, KS2 are modulated up accordingly. A “one” pulse of the pulse sequence at one of the optical switches OS1, OS2 for example means “branch”, while a “zero” pulse means “conduct”. A pulse source PULS, with two data pulse sequence generators PULSTRAIN1, PULSTRAIN2 connected in parallel downstream from it, is used here to generate any two pulse sequences for both sets of channels to be branched AS1, AS2, the output signals of said pulse source PULS being the required control signals KS1, KS2. As a result the branching of the channels AS1, AS2 is activated simultaneously and in a channel-specific manner in both incoming time-division multiplex signals S1, S2. The facilities for generating and controlling the control pulses PULSTRAIN1, PULSTRAIN2 can also be connected to the phase detector PDR for time synchronization purposes.

If two time-division multiplex signals S1, S2 respectively have a total number M of time-division multiplexed channels, of which a number H or K of channels are conducted in the optical switches OS1, OS2, the control signals KS1, KS2 should be configured such that the first total number H+J and the second total number K+L of channels going out from the optical switches OS1, OS2 is less than or equal to the total number of channels of a time-division multiplex signal SS1, SS2 going out from the optical combiner OS1, OS2.

FIG. 2 also shows the specific instance according to FIG. 1 where the number and sequence of channels AS1, AS2 to be switched are the same. In this instance the configuration of the two control signals KS1, KS2 is simplified, such that their pulse sequences are identical. Therefore only one data pulse sequence generator PULSTRAIN1 with two identical output signals KS is required.

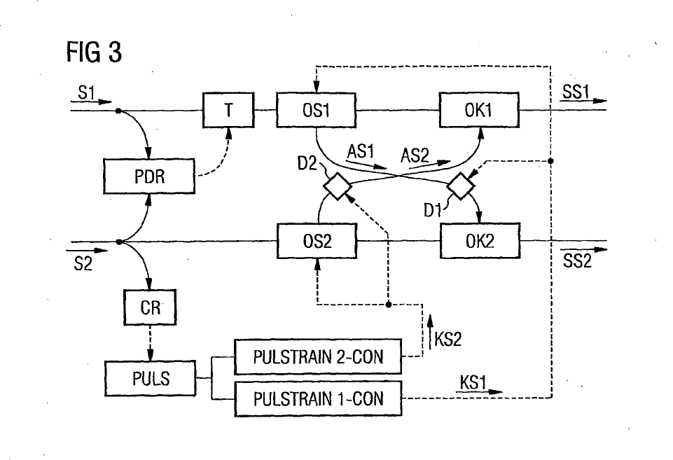

FIG. 3 shows an extension of the arrangement according to FIG. 1. The delay element T is only used to synchronize the time-division multiplex signals S1 and S2. Two further delay elements D1 and D2, which are controlled by two control facilities PULSTRAIN1-CON and PULSTRAIN2-CON, which also generate pulses for the signals to be branched as before, can now be used to delay these signals individually and then insert them into any free time slot in the other time-division multiplex signal.

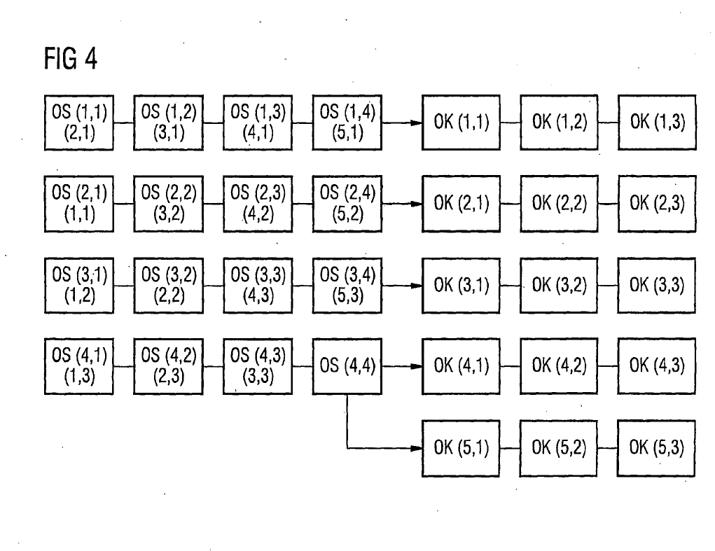

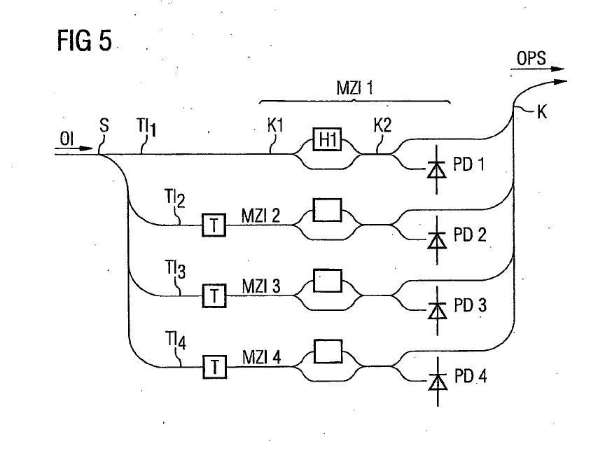

FIG. 4 shows a schematic diagram of an inventive cross-connector with 4 inputs and 5 outputs. The cross-connector can be extended to any number N of inputs and P of outputs. A time-division multiplex signal is emitted at each input of the cross-connector, i.e. at each input of a first optical switch OS(i, 1)—where i is a whole number and 0≦i≦4—of serially connected series of further optical switches (OS(i,j)—where j is a whole number and 0≦j≦4. A total of four time-division multiplex signals will pass via a series of four (or P−1 with P outputs) optical switches, e.g. for the first time-division multiplex signal via the optical switches OS(1,1), OS(1,2), OS(1,3), OS(1,4). According to FIG. 1 or 2 optical combiners OK(x,y)—where x,y are whole numbers and 0≦×≦5, 0≦y≦3—are connected downstream from the optical switches OS(i,j) such that three or N−1 serially connected optical combiners {OK(1,1), OK(1,2), OK(1,3)} or {OK(2,1), OK(2,2), OK(2,3)} or {OK(3,1), OK(3,2), OK(3,3)} or {OK(4,1), OK(4,2), OK(4,3)} follow the outputs of the four or (P−1) optical switches OS(1,4), OS(2,4), OS(3,5), OS(4,4). A further series of three or N−1 serially connected optical combiners {OK(5,1), OK(5,2), OK(5,3)} is also connected for example to one of the outputs of the optical switch OS(4,4). For reasons of clarity not all the links between outputs of all the optical switches OS(i,j) and the optical combiners OK(x,y) are shown but the number pairs in cursive brackets in the components indicate the optical combiners OK(x,y) to which one of the outputs of an optical switch OS(i,j) is connected. The outputs of the optical combiners OK(1,3), OK(2,3), OK(3,3), OK(4,3), OK(5,3) form the five or P outputs of the cross-connector.

FIG. 5 shows a schematic diagram of an arrangement for generating any sequence of control signals, as required to branch or insert individual channels. The control signals are optical pulses, which are synchronized with the clock pulse of the data signals, i.e. the OTDM data rate (in this instance G) and the pulse duration of which corresponds approximately to a bit duration.

An optical pulse O1 generated in a laser source with a repetition rate corresponding to the basic data rate (in this instance F) is split by a splitter S at the input of the inventive arrangement into N sub-pulses T11 to TIN. In the variant shown in FIG. 5 N=4. The individual sub-pulses T11 to T14 pass through different path lengths, which are selected such that transit time of each optical sub-pulse differs in each instance by a whole number multiple of a bit duration of the OTDM data rate. The different transmit times are set using delay units T. The sub-pulses T11 to T14 with such a time offset are combined at the output by means of a combiner K to form a pulse sequence OPS, in which there is a sub-pulse for each time slot. A control signal contains just one sub-pulse or individual pulse generated thus.

The inventive arrangement can for example comprise a monolithically integrated or discrete waveguide structure.

Any pulse sequence of the control signals made up of “one” pulses and “zero” pulses, as required to branch or insert individual channels, is generated by inserting optical switches within the path lengths of the sub-pulses T11 to T14. In monolithically integrated waveguide structures such a switch can for example be in the form of a Mach-Zehnder interferometer (MZI). FIG. 5 shows such a structure as one variant. The sub-pulse T11 is fed to a first coupler K1 and split into two further sub-pulses. One of these sub-pulses undergoes phase displacement, in that the optical path length of the one interferometer arm is varied by heating in the heating element HI. Depending on phase displacement, one of the sub-pulses is switched through via the coupler K2 to the combiner K at the output of the overall arrangement. Photodiodes (PD 1, PD2, . . . ) at the “open” outputs of the Mach-Zehnder interferometer are used to activate the heating elements correctly. If a “one” is generated, i.e. if the corresponding channel is to be branched, the heating element is regulated such that there is no intensity present at the photodiode and a sub-pulse is forwarded as a control signal. Otherwise it is regulated to maximum intensity at the photodiode. The arrangement shown in FIG. 5 is configured by way of example for a 4×40 GBit/s OTDM system. This means that with an overall data rate of 160 GBit/s the delays of the sub-pulses T11 to T14 in the respectively associated waveguides is 6.25 ps. If the waveguides have a refractive index of around 1.5, this corresponds to length differences of around 1.25 mm. It is also possible to generate the control signal such that the number N of sub-pulses corresponds precisely to the number M of channels of the time-division multiplex signal, to achieve total flexibility in respect of the number of channels to be switched.

1-7. (canceled)

8. A cross-connector for optical signals comprising,
N inputs,
P outputs (N>1, P>1),
the optical signals having time-division multiplexed channels,
at least two optical switches, each configured to have optical signals fed in each instance to on of the optical switches.
at least two optical combiners connected downstream of the optical switches,
wherein the first optical switch is configured to branch a first number of channels to feed to the second optical combiner and
wherein the second optical switch is configured to branch a second number of channels from the second optical signal to feed to the first optical combiner, and
means for generating a plurality of optical control signals for controlling the at least two optical switches.

9. The cross-connector according to claim 8, wherein the optical combiners comprise,
a detection unit to determine the occupancy of incoming time-division multiplexed channels, and
means for reciprocal time displacement or reassignment of channels.

10. The cross-connector according to claim 8, further comprising a plurality of delay elements arranged between the optical switches and the optical combiners, and being connected to a control facility and allowing time synchronization of the time-division multiplex signals.

11. The cross-connector according to claim 8, further comprising means for producing a sequence of pulses as control signals for controlling the addition or branching of channels in the non-demultiplexed time-division multiplex signal.

12. The cross-connector according to claim 8, further comprising a pulse source with means for producing output signals as control signals having pulse sequences, the maximum bit rate of which is the bit rate of the time-division multiplex signals.

13. The cross-connector according to claim 8, wherein the means for generating the control signals comprises,
a splitter having means for splitting a pulse signal, having a basic data rate of the time-division multiplex signal, into a number of sub-pulses,
a number of transit time elements,
wherein the splitter is configured to feed one of the sub-pulses in each instance to a predetermined number of transit time elements, and
wherein the transit time elements have transit times that differ by a whole number multiple of a bit duration,
wherein the optical switches are arranged in series with each transmit time element, and
wherein a combiner is connected downstream from the optical switches and configured to combine delayed sub-pulses to form control signals.

14. A cross-connector arrangement as claimed in claim 13, wherein the optical switches comprise, Mach-Zehnder interferometers combined with photodiodes configured such that the addition, branching or time displacement of data of one of the time-division multiplexed channels of the time-division multiplex signal is carried out as a channel-related operation.

15. A cross-connector according to claim 13, wherein the control signals are optical pulses synchronized with the clock pulse of the data signals.

16. A cross-connector according to claim 13, wherein the splitter comprises means for splitting an optical pulse generated by a laser source with a repetition rate corresponding to the basic data rate.

17. A cross-connector according to claim 13, wherein the means for generating control signals comprises means for generating control signals such that the number of sub-pulses corresponds precisely to the number of channels of the time-division multiplex signal for flexibility in the number of channels to be switched.
